(19) United States
(12) Patent Application Publication
(10) Pub. No.: US 2007/0288420 A1
(43) Pub. Date: Dec. 13, 2007

(54) METHOD OF FAST ONE-WAY SEARCH AND DATABASE THEREOF

(75) Inventor: Wei-fong Hsu, Shijr City (TW)

Correspondence Address: MADSON & AUSTIN, 15 WEST SOUTH TEMPLE, SUITE 900, SALT LAKE CITY, UT, 84101, US

(73) Assignee: Aten International Co., Ltd., Shijr City (TW)

(21) Appl. No.: 11/423,012

(22) Filed: Jun. 8, 2006

(51) Int. Cl. G06F 17/30

(52) U.S. Cl. 707/1

(57) ABSTRACT

A method of fast one-way search and the database thereof is disclosed. The database comprises a plurality of records. Record IDs of section headers obtained by dividing the database are stored in a first table. Record IDs with continuous position addresses previous to that of a last found record are stored in a second table. The method comprising: receiving a data portion request; determining whether the position address of a currently requested record is previous to that of the last found record, if so, conducting one-way search for the currently requested record in the second table; determining whether the record ID of the currently requested record is found in the second table, if not, conducting one-way search for the currently requested record beginning from the section header nearest to and less than the position address of the currently requested record.

### FIELD OF THE INVENTION

The present invention generally relates to a method of fast one-way search and database thereof, and more particularly to a method of fast one-way search with a section header table obtained by dividing the database averagely into sections and database thereof.

### BACKGROUND OF THE INVENTION

In early years, a database sorting numbers of records is usually structured in a sequential representation such as arrays, stacks or queues. The database structure of the sequential representation has the advantage of fast accessing to individual requested data. The drawback is moving large amount of records is a necessity for an adding or deleting motion to the database. Speaking of a database, which needs adding or deleting records therein frequently, the sequential representation is not a good structure for the database. Therefore, linked lists, structuring a database is a good model for present usage, which only needs to change the linking when adding or deleting some records therein happens. Therefore, in recently developed database structure, linked lists are preferred to be employed as the data structure for an algorithm therefore. Specifically, singly linked lists, which structure a one-way search database are comparatively much employed rather than doubly linked lists or trees.

Although, more running time than doubly linked lists or trees but much less memory capacity is required, which is quite a benefit for an electric circuitry and for a large database, searched with less memory, such as a IPMI database which is accessed by a remote console far away. Practically, it is impossible to catch all the records and data portion of the database back to the console and search it, but to catch tiny portion of the records to save in the memory of the console and catch other records on demand. However, searching in this kind of database, that the structure is the singly linked lists also has one drawback that once the current requested record is previous to the position of the last requested record along the way of the database, searching has to be started from the beginning of the database to reach the current requested record. In case of aforesaid network database or other same situation, it will take much longer than the doubly linked lists.

Consequentially, there is a need to develop a method of fast one-way search and database thereof to provide an efficient performance of searching in such database with singly linked lists.

### SUMMARY OF THE INVENTION

To solve the foregoing drawbacks in the prior art, it is an objective of the present invention is to provide a method of fast one-way search for a database and the database thereof.

To accomplish the above objective, the present invention provides a method of fast one-way search for a database comprising a plurality of records, each of the records comprising at least a record ID corresponding to a position address of each record in the database, a next record ID corresponding to a next position address of a next record in the database and a data portion, wherein the database is divided into a plurality of sections, first records of the sections are assigned as section headers and the record IDs of the section headers are stored in a first table, wherein a plurality of record IDs with position addresses previous to a position address of a last found record are stored in a second table. The method comprising steps of:

a. receiving a data portion request;

b. determining whether the position address of a currently requested record comprising the requested data portion is previous to a position address of the last found record, if so, conducting one-way search of a record ID of the currently requested record in the second table;

c. determining whether the record ID of the currently requested record is found in the second table, if so, delivering the data portion of the currently requested record via the found record ID; and

d. storing the plurality of record IDs with position addresses previous to the position address of the found record ID in the second table.

In step c, if the record ID of the currently requested record is not found, the method of fast one-way search further comprising steps of:

c1. selecting a section header via the record IDs in the first table such that a position address of the selected section header is nearest to and less than the position address of the currently requested record;

c2. conducting one-way search for the record ID of the currently requested record in the database, beginning from the selected section header, until the record ID of the currently requested record is found; and

c3. delivering the data portion of the currently requested record via the found record ID.

The database capable of conducting fast one-way search according to the present invention comprises a plurality of records and a first table. Each of the records comprises at least a record ID corresponding to a position address of each record in the database, a next record ID corresponding to a next position address of a next record in the database, and a data portion, wherein the database is divided into a plurality of sections, first records of the sections are assigned as section headers. The first table is stored with the record IDs of the section headers.

The database further comprises a second table. The second table is stored with a plurality of record IDs that the data portions of the record IDs are more frequently requested. Alternatively, the second table is stored with a plurality of record IDs with position addresses thereof previous to a position address of a last found record. As aforementioned, a total number of the position addresses in the database is obtained before receiving a data portion request during the initialization of the database. The database is divided into the sections averagely according the total number of the position addresses to assign the first records of the sections as section headers.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a structure diagram of the database capable of conducting fast one-way search according to the present invention.

FIG. 2 shows explanatory contents of the first table and the second table according to the present invention.

FIG. 3 illustrates a structure diagram of the database to expound a situation that the position address of a currently requested data is previous to the position address of a last found record and not in the second table.

FIG. 4 illustrates a flowchart of the method of fast one-way search according to a first embodiment of the present invention.

FIG. 5 illustrates a flowchart of the method of fast one-way search according to a second embodiment of the present invention.

### DETAILED DESCRIPTION OF THE PERFERRED EMBODIMENTS

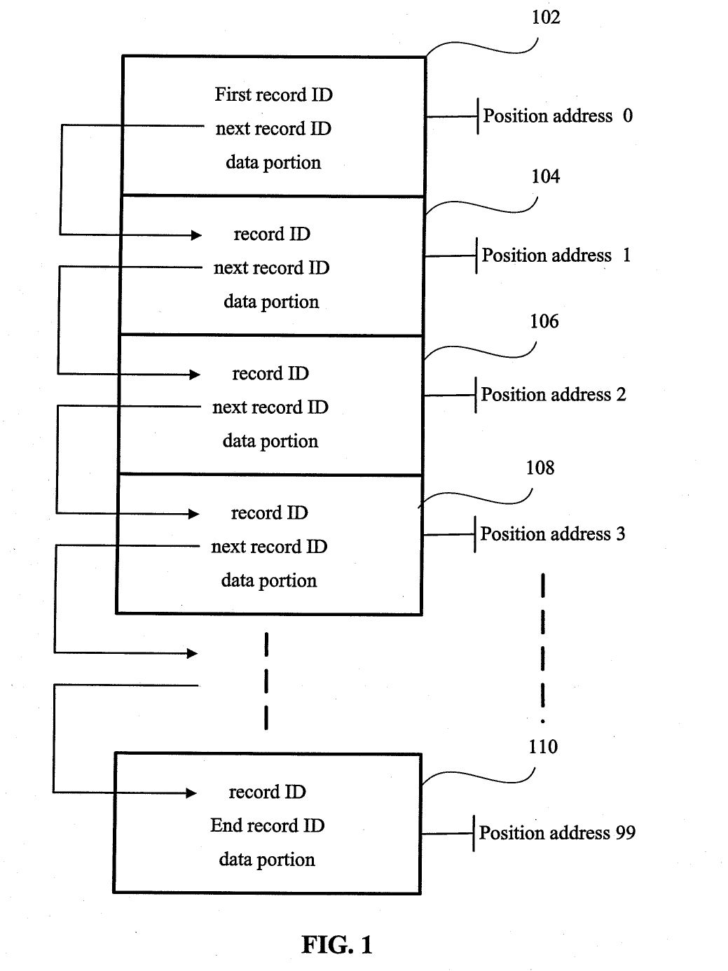

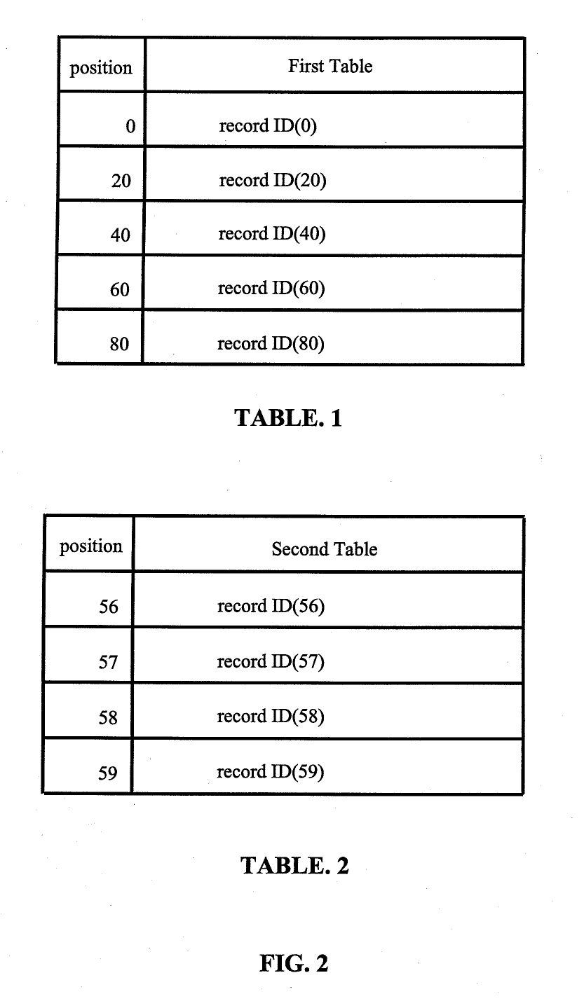

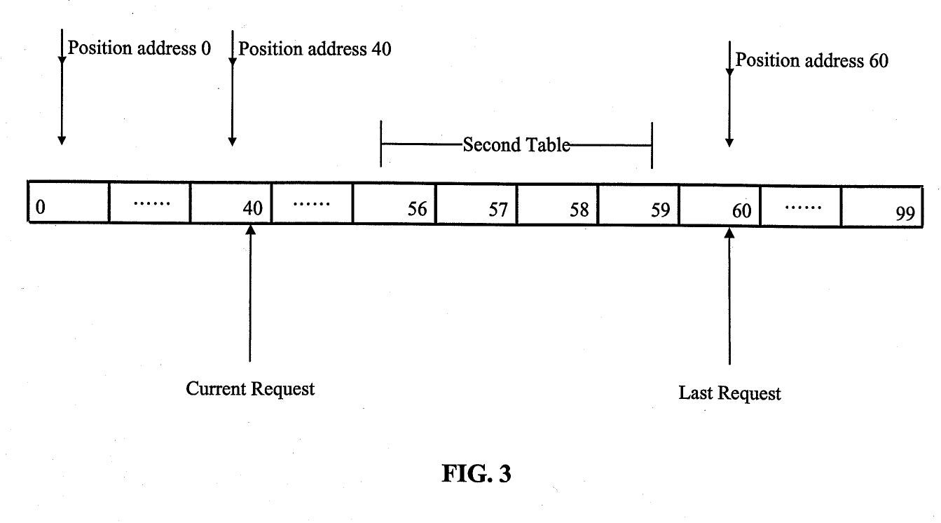

Please refer to FIG. 1 with FIG. 2 and FIG. 3. FIG. 1 illustrates a structure diagram of the database capable of conducting fast one-way search according to the present invention. FIG. 2. shows explanatory contents of the first table and the second table for the fast one-way search according to the present invention. FIG. 3. illustrates a structure diagram of the database to expound a situation that the position address of a currently requested data is previous to the position address of a last found record and not in the second table.

The explanatory database according to the present invention comprises 100 records, a first table and a second table. The record 102 comprises a record ID (the first record ID) corresponding to position address 0, a next record ID of record 104 corresponding to position address 1 and a data portion. The record 104 comprises a record ID corresponding to position address 1, a next record ID of record 106 corresponding to position address 2 and a data portion. The record 106 comprises a record ID corresponding to position address 2, a next record ID of record 108 corresponding to position address 3 and a data portion and so on. And finally, the record 110 comprises a record ID corresponding to position address 99, an end record ID indicating the end of the database, and a data portion. Such singly linked lists structure a basic of a one-way search database.

During the initialization of the database, the database is divided into the sections averagely according a total number of the position addresses of the first table. The first record of each of the sections is assigned as section header and the first table is stored with the record IDs of the section headers. Meanwhile, the second table is stored with the record IDs a plurality of records selected from the database. Please refer to TABLE. 1 shown in FIG. 2. The total number of the position addresses in the database is said 100 and the total number of the position addresses of the first table is 5. Therefore, after dividing the database averagely, the record IDs of the section headers, record ID(0), record ID(20), record ID(40), record ID(60), record ID(80), and the corresponded position addresses 0, 20, 40, 60, 80 of the section headers are stored in the first table. The second table may store preliminary position addresses 0, 1, 2, 3 of the database as default. Thereafter, the second table is updated with record IDs with position addresses thereof previous to a position address of a last found record as shown in FIG. 3 is in a case that the position address 40 of a currently requested data is previous to the position address 60 of the last found record, the second table is stored with record IDs with position addresses 56, 57, 58, 59 thereof continuous and nearest to the position address 60 of the last found record.

Specifically, the explanatory first table is stored with five record IDs and the explanatory second table is stored with four record IDs. The storage numbers of the tables are predetermined according to the memory capacity of the database design. Alternatively, the second table can be stored with record IDs that the data portions thereof are more frequently requested.

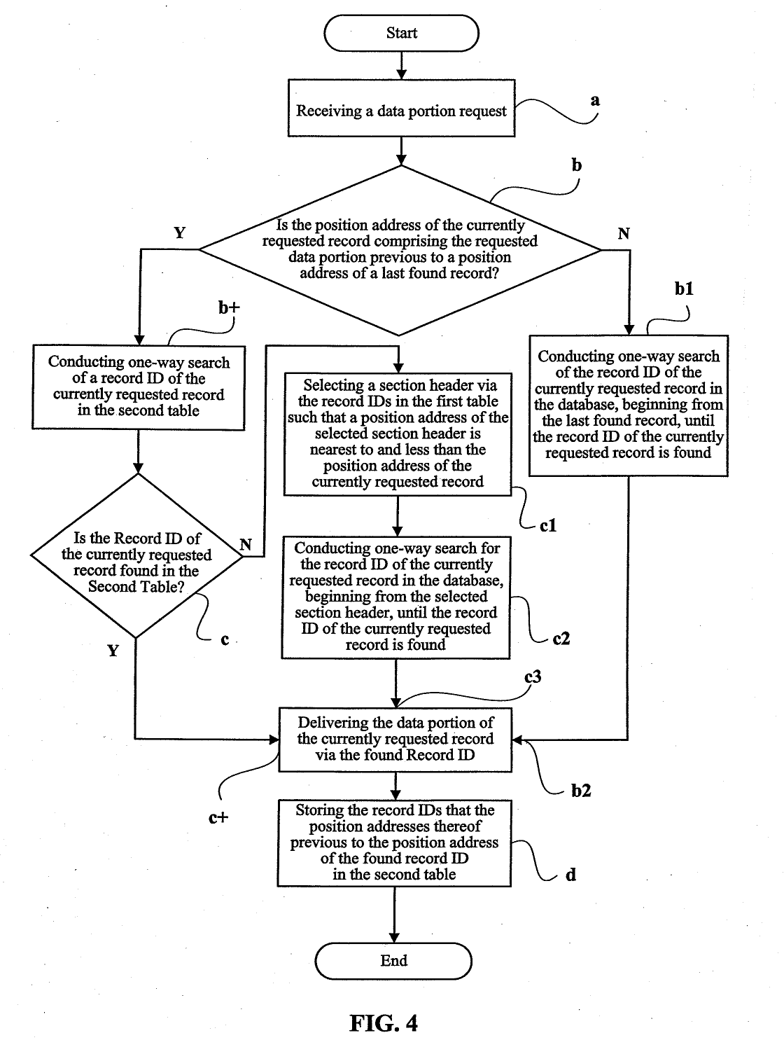

Please refer to FIG. 4. It illustrates a flowchart of the method of fast one-way search according to first embodiment of the present invention. With the first table and second table, the method of fast one-way search for the database structured by aforementioned singly linked lists shown in FIG. 1 can be achieved. In the first embodiment, the method comprises steps of:

a. receiving a data portion request;

b. determining whether the position address of a currently requested record comprising the requested data portion is previous to a position address of the last found record;

if not, then b1. conducting one-way search of the record ID of the currently requested record in the database, beginning from the last found record, until the record ID of the currently requested record is found;

if so, then b+. conducting one-way search of a record ID of the currently requested record in the second table;

c. determining whether the record ID of the currently requested record is found in the second table;

if so, then c+. delivering the data portion of the currently requested record via the found record ID;

if not, then c1. selecting a section header via the record IDs in the first table such that a position address of the selected section header is nearest to and less than the position address of the currently requested record;

c2. conducting one-way search for the record ID of the currently requested record in the database, beginning from the selected section header, until the record ID of the currently requested record is found; and

c3. delivering the data portion of the currently requested record via the found record ID.

After the steps c+, c3, or b2 of delivering the data portion, the method will proceed the step d. storing the plurality of record IDs with position addresses previous to the position address of the found record ID in the second table and wait for next data portion request.

The method of fast one-way search further comprises a step of obtaining a total number of the position addresses in the database for dividing the database averagely into the sections for obtaining the first table during the initialization of the database. Furthermore, the method of fast one-way search further comprises a step of storing a plurality of record IDs of preliminary position addresses of the database in the second table after the initialization. The position addresses in the second table are continuous and nearest to the found record ID.

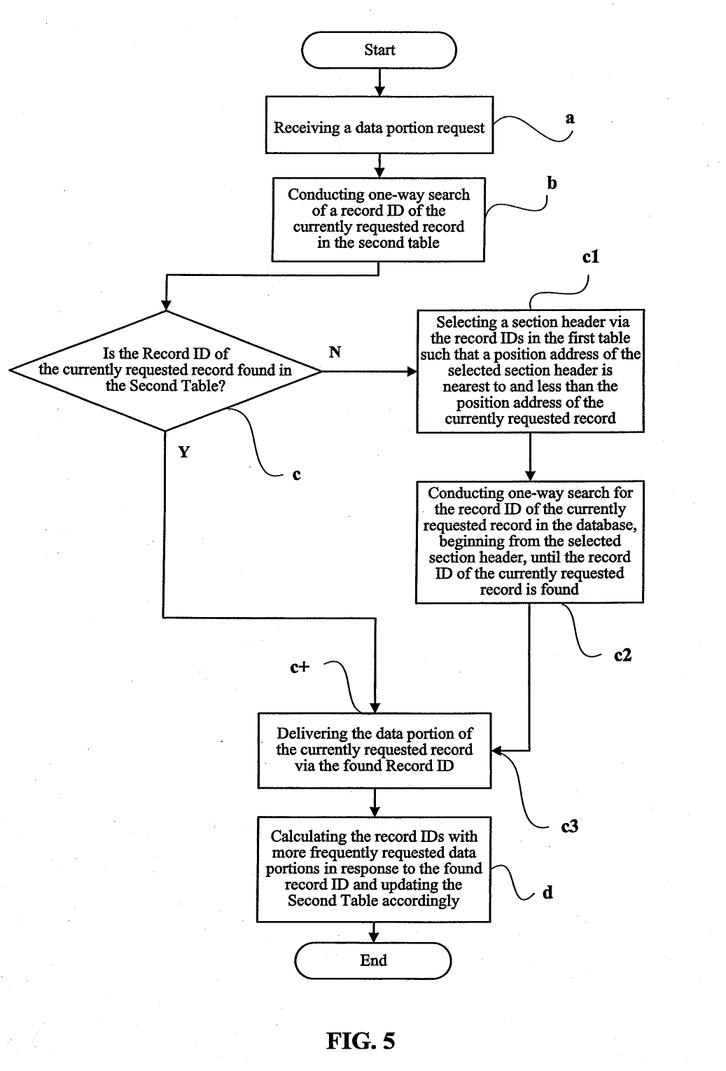

Please refer to FIG. 5. It illustrates a flowchart of the method of fast one-way search according to second embodiment of the present invention. In the second embodiment, the second table is stored with a plurality of record IDs that the data portions of the record IDs are more frequently requested. The method comprises steps of:

a. receiving a data portion request;

b. conducting one-way search of a record ID of a currently requested record in the second table;

c. determining whether the record ID of the currently requested record is found in the second table;

if so, then c+, delivering the data portion of the currently requested record via the found record ID;

if not, then c1. selecting a section header via the record IDs in the first table such that a position address of the selected section header is nearest to and less than the position address of the currently requested record;

c2. conducting one-way search for the record ID of the currently requested record in the database, beginning from the selected section header, until the record ID of the currently requested record is found; and

c3. delivering the data portion of the currently requested record via the found record ID.

After the steps c+ or c3 of delivering the data portion, the method according to the present invention will proceed the step d. calculating the record IDs with more frequently requested data portions in response to the found record ID and updating the second table accordingly. The method of fast one-way search according to the present invention provides the first table stored with the record IDs of the section headers. Even the position address of the current requested record is previous to the position address of the last requested record, it is not necessary for searching of the data portion request to be started from the beginning of the database but the method according to the present invention selects a section header nearest to and less than the position address of the currently requested record and conducts search for the record ID of the currently requested record therefrom.

The method of fast one-way search according to the present invention further provides the second table, stored with the record IDs with position addresses previous to a position address of a last found record. If the position address of the currently requested record is found in the second table, the method can fast conduct the search of the record ID of the currently requested record to deliver the data portion via the found record ID.

In conclusion, the method of fast one-way search and database thereof according to the present invention can search in the database structured with singly linked lists more efficiently.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A method of fast one-way search for a database comprising a plurality of records, each of the records comprising at least a record ID corresponding to a position address of each record in the database, a next record ID corresponding to a next position address of a next record in the database and a data portion, wherein the database is divided into a plurality of sections, first records of the sections are assigned as section headers and the record IDs of the section headers are stored in a first table, wherein a plurality of record IDs with position addresses previous to a position address of a last found record are stored in a second table, the method comprising the following steps:
a. receiving a data portion request;
b. determining whether the position address of a currently requested record comprising the requested data portion is previous to a position address of the last found record, if so, conducting one-way search of a record ID of the currently requested record in the second table;
c. determining whether the record ID of the currently requested record is found in the second table, if so, delivering the data portion of the currently requested record via the found record ID; and
d. storing the plurality of record IDs with position addresses previous to the position address of the found record ID in the second table.

2. The method of claim 1, wherein in step d, the position addresses are continuous and nearest to the found record ID.

3. The method of claim 1, wherein in step c, if the record ID of the currently requested record is not found in the second table, further comprising the following steps:
c1. selecting a section header via the record IDs in the first table such that a position address of the selected section header is nearest to and less than the position address of the currently requested record;
c2. conducting one-way search for the record ID of the currently requested record in the database, beginning from the selected section header, until the record ID of the currently requested record is found; and
c3. delivering the data portion of the currently requested record via the found record ID.

4. The method of claim 1, wherein in step b, if the position address of a currently requested data is not previous to the position address of the last found record, further comprising the following steps:
b1. conducting one-way search of the record ID of the currently requested record in the database, beginning from the last found record, until the record ID of the currently requested record is found; and
b2. delivering the data portion of the currently requested record via the found record ID.

5. The method of claim 1, further comprising a step of obtaining a total number of the position addresses in the database for dividing the database averagely into the sections before step a.

6. The method of claim 1, further comprising a step of storing a plurality of record IDs of preliminary position addresses of the database in the second table before step a.

7. A database capable of conducting fast one-way search, the database comprising:
a plurality of records, each comprising at least a record ID corresponding to a position address of each record in the database, a next record ID corresponding to a next position address of a next record in the database, and a data portion, wherein the database is divided into a plurality of sections, first records of the sections are assigned as section headers; and
a first table for storing the record IDs of the section headers.

8. The database of claim 7, further comprising a second table for storing a plurality of record IDs that the data portions of the record IDs are more frequently requested.

9. The database of claim 7, further comprising a second table for storing a plurality of record IDs with position addresses thereof previous to a position address of a last found record.

10. The database of claim 7, wherein a total number of the position addresses in the database is obtained before receiving a data portion request.

11. The database of claim 10, wherein the database is divided into the sections averagely according the total number of the position addresses.

12. A method of fast one-way search for a database comprising a plurality of records, each of the records comprising at least a record ID corresponding to a position address of each record in the database, a next record ID corresponding to a next position address of a next record in the database and a data portion, wherein the database is divided into a plurality of sections, first records of the sections are assigned as section headers and the record IDs of the section headers are stored in a first table, wherein a plurality of record IDs with more frequently requested data portions are stored in a second table, the method comprising the following steps:
a. receiving a data portion request;
b. conducting one-way search of a record ID of a currently requested record in the second table;
c. determining whether the record ID of the currently requested record is found in the second table, if so, delivering the data portion of the currently requested record via the found record ID; and
d. calculating the record IDs with more frequently requested data portions in response to the found record ID and updating the second table accordingly.

13. The method of claim 12, wherein in step c, if the record ID of the currently requested record is not found in the second table, further comprising the following steps:
c1. selecting a section header via the record IDs in the first table such that a position address of the selected section header is nearest to and less than the position address of the currently requested record;
c2. conducting one-way search for the record ID of the currently requested record in the database, beginning from the selected section header, until the record ID of the currently requested record is found; and
c3. delivering the data portion of the currently requested record via the found record ID.

14. The method of claim 12, further comprising a step of obtaining a total number of the position addresses in the database for dividing the database averagely into the sections before step a.

15. The method of claim 12, further comprising a step of storing a plurality of record IDs of preliminary position addresses of the database in the second table before step a.
